(19) United States
(12) Patent Application Publication
(10) Pub. No.: US 2011/0176787 A1
(43) Pub. Date: Jul. 21, 2011

(54) SYSTEMS AND METHODS FOR PROVIDING ENHANCED RECORDING OPTIONS OF MEDIA CONTENT

(75) Inventor: Gregory L. DeCamp, Simi Valley, CA (US)

(73) Assignee: UNITED VIDEO PROPERTIES, INC., Los Angeles, CA (US)

(21) Appl. No.: 12/910,024

(22) Filed: Oct. 22, 2010

Related U.S. Application Data
(63) Continuation of application No. 11/961,252, filed on Dec. 20, 2007, now abandoned.
(60) Provisional application No. 61/013,721, filed on Dec. 14, 2007.

(51) Int. Cl. H04N 9/80; H04N 5/76

(52) U.S. Cl. 386/241; 386/297; 386/E05.003

(57) ABSTRACT

Systems and methods for providing enhanced recording options for media content are provided. The systems and methods permit users to view or otherwise access samples of media content before deciding whether to record additional episodes of the media content or to perform other media guidance application functions. An interactive media guidance application implemented at least partially on a user's equipment displays at least one media content listing. A user may then select to record a sample or portion of the media content listing. After the user has subsequently viewed at least a portion of the recorded media content, the interactive media guidance application may provide an option to record an entire version of the recorded sample, record another episode of the media content, record an entire series of the media content, erase the recorded sample, or perform other media guidance application functions.

This application claims the benefit of U.S. Provisional Application No. 61/013,721, filed Dec. 14, 2007, the disclosure of which is hereby incorporated by reference herein in its entirety.

### BACKGROUND OF THE INVENTION

This invention relates generally to media systems, and more particularly, to media systems that permit recording of media content.

An interactive media guidance application allows a user to more easily navigate through the wide array of media content accessible by a typical user's equipment. The media content accessible by a typical user's equipment may include hundreds of broadcast television channels, interactive applications (e.g., interactive games), digital music, on-demand content (e.g., video on-demand (VOD) content), Internet resources, and recorded content (e.g., content recorded to a local video recorder).

An interactive media guidance application may also perform one of several media guidance application functions on content accessible by a user's equipment. These media guidance application functions may include scheduling the selected content to be recorded, recording the selected content to a local storage device or remote media server, adding the selected content to a favorite programs list, setting a reminder for the selected content, ordering the selected content via an on-demand (e.g., video on-demand or VOD) or pay-per-view (PPV) service, or any other suitable function. For example, a user may record any content listed in a media guidance application schedule listing by placing the highlight region on the content listing and pressing a “Record” button on an input device such as a remote control device. Moreover, the user may schedule upcoming content (e.g., broadcast television scheduled to be aired in the future) for automatic recording. In such systems, when a user has scheduled content to be recorded, the interactive media guidance application may automatically cause the user's equipment to tune to the content after it becomes available, send a record command to a local storage device (or remote media server) to begin recording the content, and then stop recording at the conclusion of the content broadcast. The interactive media guidance application may also allow the user to schedule periodic recordings (e.g., daily or weekly recordings) so that each episode of a program series are automatically recorded at a specified time and on a specified channel.

An example of a system with program series recording functionality is found in Young et al. U.S. Pat. No. 6,498,895, which is hereby incorporated by reference herein in its entirety. This system permits, for example, recording of episodes within a television program series.

U.S. Patent App. Pub. No. 2005/0204388 to Knudson et al., which is hereby incorporated by reference herein in its entirety, describes a media system that provides more advanced series recording features.

Unfortunately, the ease at which users can record media content often results in over-recording. For example, after missing several weeks of a recorded series, a user may have dozens of recorded, unseen episodes available on a digital video recorder (DVR) or remote media server. The user may not have time to watch all the recorded episodes or even be interested in watching them. Over time, DVRs or other media storage devices may become full, requiring users to delete previously-recorded media content before additional media content can be recorded.

The problem of over-recording is exacerbated by the way existing media systems require users to select recording options for programs or other media content. Specifically, typical media guidance applications list available media content and allow users to schedule media content for recording by highlighting a desired media content listing, pressing a “Record” button, and then choosing to record a particular episode or an entire series. Because users must select a recording option before they have actually viewed the media content, users often opt to record an entire series, and then after viewing a few recorded episodes, decide they do not like the media content after all. Many such users then forget to cancel a series recording request and do not delete the unwanted recordings until their DVRs or other recording devices are full.

The problem of over-recording is also exacerbated by recommendation features provided by many media guidance applications. To simplify and facilitate the discovery of new media content, many interactive media guidance applications now provide recommendations based on the users' own viewing habits, editorial programming picks, or other methods. Although such recommendations may encourage recording of media content that more closely fits users' preferences, the users must still decide whether to record the recommendations before viewing them and deciding whether they are truly of interest. Thus, many users simply record all media content recommended to them and never actually watch many of the recommendations.

Existing media systems also sometimes cause under-recording of media content. For example, when new Fall television programs are first broadcast, some users record a single episode of a new series rather than the entire series to avoid filing up their DVRs. After watching the recorded episode, many users forget to record more episodes even if they liked the recorded episode. This is because existing media systems typically only prompt users to either “keep” or “delete” a recording after it has been played. To record more episodes or an entire series of an enjoyable episode, users must access the media guide again, search for the next broadcast time for the series, then schedule recording of the series or another selected episode.

The above described under-recording problems are even more common when users discover an enjoyable program in the middle of its first season or during subsequent seasons. Not only must these users follow the procedures mentioned above to record all remaining episodes of the series, they must also search for and record reruns of any missed episodes.

### SUMMARY OF THE INVENTION

In accordance with the principles of the present invention, systems and methods for providing enhanced recording options and other media guidance application functions for media content are provided. In general, embodiments of the systems and methods permit users to view or otherwise access samples of media content before deciding whether to record related media content such as additional episodes of the media content or to perform other media guidance application functions.

In an exemplary embodiment, an interactive media guidance application implemented at least partially on a users equipment displays at least one media content listing. The media content listing may be a television program listing and may list the title of the television program, its broadcast time, and other relevant information. A user may select to record a sample or portion of the media content listing. In some embodiments, the user may do so by highlighting the media content listing and pressing a “Record” button on a remote control device or other input device. The media guidance application then schedules recording of the sample. After the user has viewed at least a portion of the recorded media content, the media guidance application may provide an option to schedule a related media content. For example, the user may be presented with an option to record an entire version of the recorded sample, another episode of the media content, or an entire series of the media content. If the recorded media content is an episode of a series other than the first episode, the media guidance application may also present an option to record missed episodes of the series. The user may also be presented with an option to erase the recorded sample or to perform other media guidance application functions. Importantly, the option to schedule another recording or to perform another media guidance application function is presented to the user after the user has viewed at least a portion of the recorded sample. This allows the user to decide whether he or she likes the media content before committing to the recording of more episodes or an entire series.

In another exemplary embodiment, an interactive media guidance application implemented at least partially on a user's equipment displays at least one media content listing for a media content which has been recommended to the user. The media content may have been recommended by an editor or based at least in part on user profile information derived from historical user viewing information and/or user profile information. The media content listing may be a television program listing and may list the title of the television program, its broadcast time, and other relevant information. After the user has viewed at least a portion of the recommended media content, the user's equipment may provide an option to schedule a recording of the recommendation or another media content related to the recommendation. For example, the user may be presented with an option to record an entire version of the recommendation, another episode of the recommendation, or an entire series for the recommendation. The user may also be presented with an option to erase the recorded sample, an option to record missed episodes, or an option to perform another media guidance application function.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative display screen that may be used to provide media guidance application listings in accordance with an embodiment of the invention;

FIG. 2 shows another illustrative display screen that may be used to provide media guidance application listings in accordance with an embodiment of the invention;

FIG. 3 shows an illustrative user equipment device in accordance with an embodiment of the invention;

FIG. 4 is a diagram of an illustrative interactive media system in accordance with an embodiment of the invention;

FIG. 5 is an illustrative display screen showing recording options on an overlay in accordance with an embodiment of the invention;

FIG. 6 is an illustrative display screen showing recording options in accordance with an embodiment of the invention;

FIG. 7 is an illustrative display screen showing media guidance application function options in accordance with an embodiment of the invention;

FIG. 8 is an illustrative display screen showing recommended media content in accordance with an embodiment of the invention;

FIG. 9 shows an illustrative process for performing a media guidance application function in accordance with an embodiment of the invention;

FIG. 10 is an illustrative display screen showing media content which has been recorded or is scheduled for recording in accordance with an embodiment of the invention; and

FIG. 11 shows an illustrative process for performing a media guidance application function in accordance with another embodiment of the invention.

### DETAILED DESCRIPTION OF THE PREFERRED EMBODIMENTS

The amount of media available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), and other types of media or video content. Guidance applications also allow users to navigate among and locate content related to the video content including, for example, video clips, articles, advertisements, chat sessions, games, etc.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

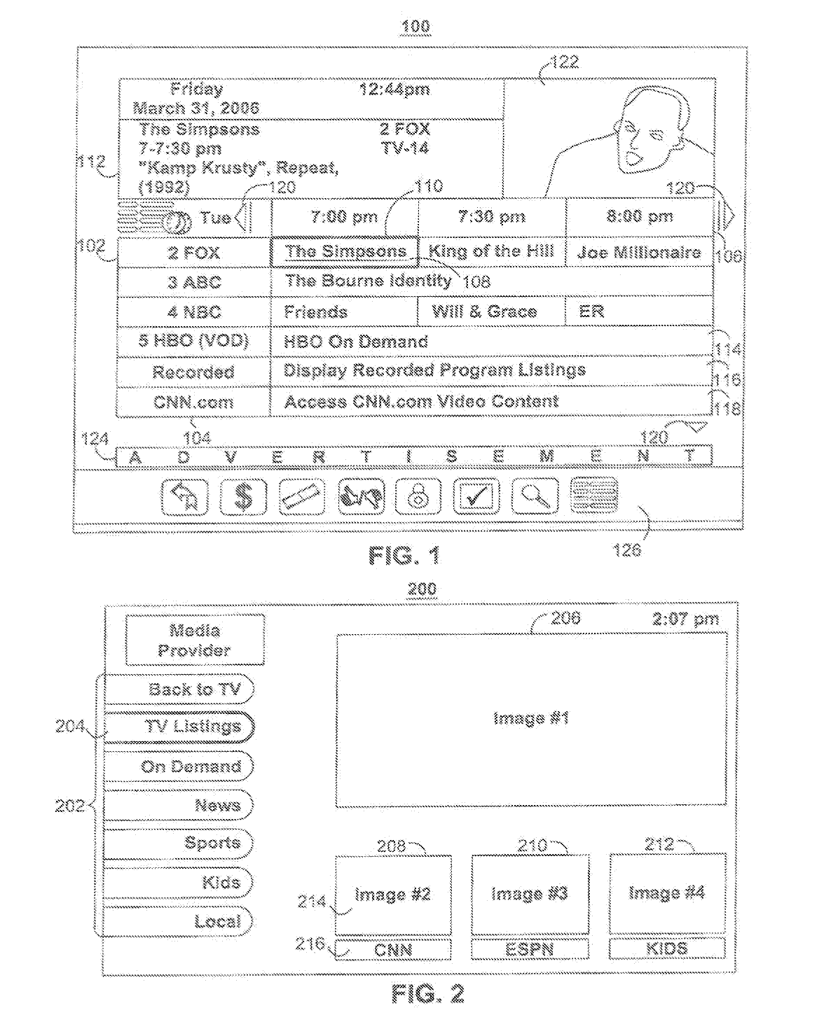

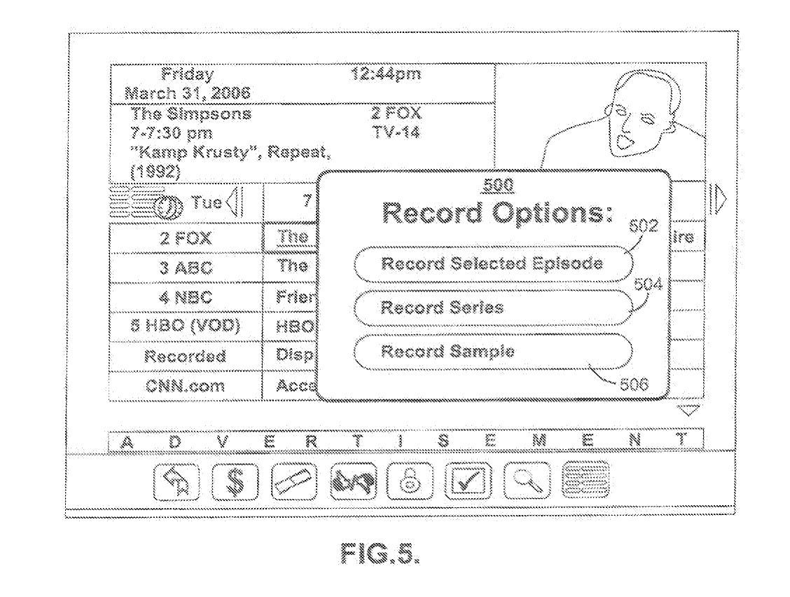

One of the functions of the media guidance application is to provide media listings and media information to users. FIGS. 1-2 show illustrative display screens that may be used to provide media guidance, and in particular media listings. The display screens shown in FIGS. 1-2 and those shown in FIGS. 5-8 and 10 may be implemented on any suitable device or platform. While the displays of FIGS. 1, 2, 5-8, and 10 are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND, THE SOPRANOS, and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g. FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. patent application Ser. No. 09/437,304, filed Nov. 9, 1999, and Ellis et al., U.S. patent application Ser. No. 10/105,128, filed Feb. 21, 2002, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, video clip previews, live video from the media content, or other types of media that indicate to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

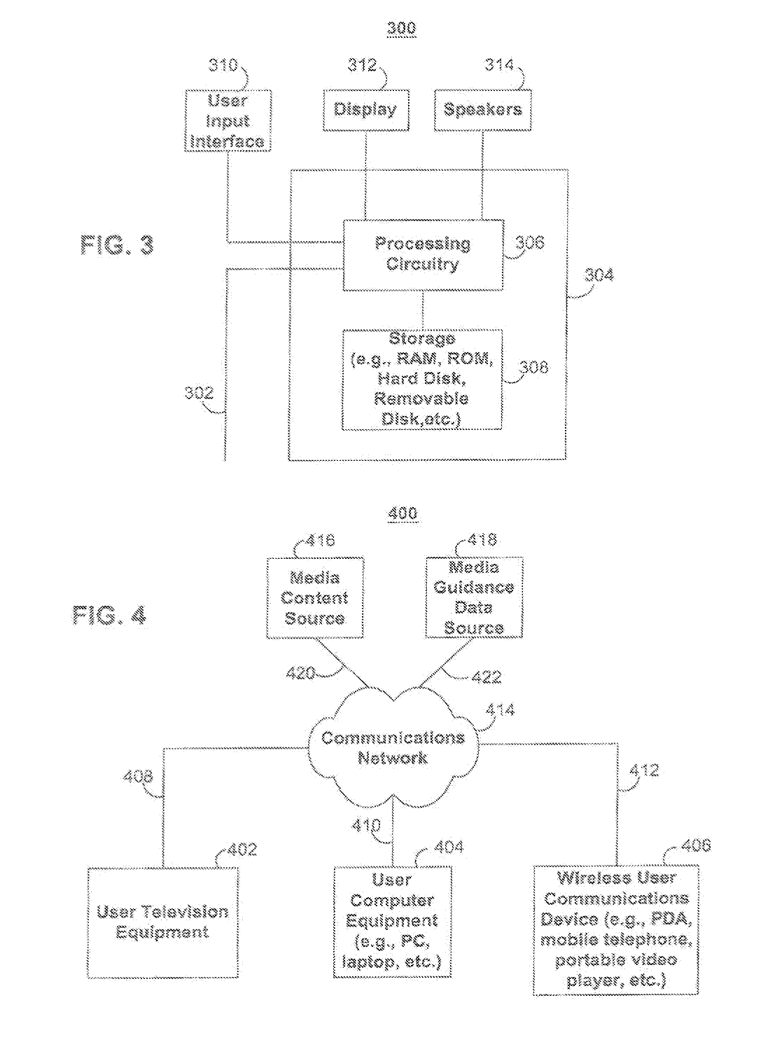

Users may access media content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a trademark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a trademark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel).

Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 416 to access media content. Specifically, within a home, users of user television equipment 404 and user computer equipment 406 may access the media guidance application to navigate among and locate desirable media content. Users may also access the media guidance application outside of the home using wireless user communications devices 406 to navigate among and locate desirable media content.

In accordance with the principles of the present invention, the above-described media guidance application, user equipment device 300 and system 400 implement systems and methods for providing enhanced recording options and media guidance application functions for media content. In general, embodiments of the invention permit users to view or otherwise access media content or samples of media content before deciding whether to record related media content such as additional episodes of the media content or to perform other media guidance application functions.

In an exemplary embodiment of the invention, an interactive media guidance application implemented at least partially on user equipment device 300 displays at least one media content listing. The media content listing may be a television program listing 108 such as the one shown in FIG. 1 and may list the title of the television program, its broadcast time, and other relevant information. A user may select to record the media content represented by the listing or to record a sample of the media content. In some embodiments, the user may do so by moving the highlight region 110 over the media content listing 108 and pressing a “Record” button on the user input device 310, which may be a remote control device or other input device.

The media guidance application may then present a record options overlay 500 such as the one illustrated in FIG. 5. The record options overlay 500 may permit conventional recording or selection of a media guidance application function in accordance with the principles of the present invention. For example, the record options overlay 500 may display a Record Selected Episode selection 502, a Record Series selection 504, and a Record Sample selection 506. If the user picks selections 500 or 504, the media guidance application schedules recording of a single episode or a series in a conventional manner.

However, if the user selects the Record Sample selection 506 or a similar selection, the media guidance application implements the principles of the present invention. In general, the media guidance application schedules recording of the selected media content and marks or otherwise identifies the recording as a sample. The recorded sample may be a portion of the media content (e.g. the first 15 minutes of a television program), the entire media content (e.g. an entire episode from a television program series), or a preview of the media content. After a user views or otherwise accesses at least a portion of the recorded sample, the media guidance application function presents additional recording options or media guidance application function options. For example, the media guidance application function may present an option to record an entire version of the sample, another episode of the sample, a whole series related to the sample, or missed episodes within a series.

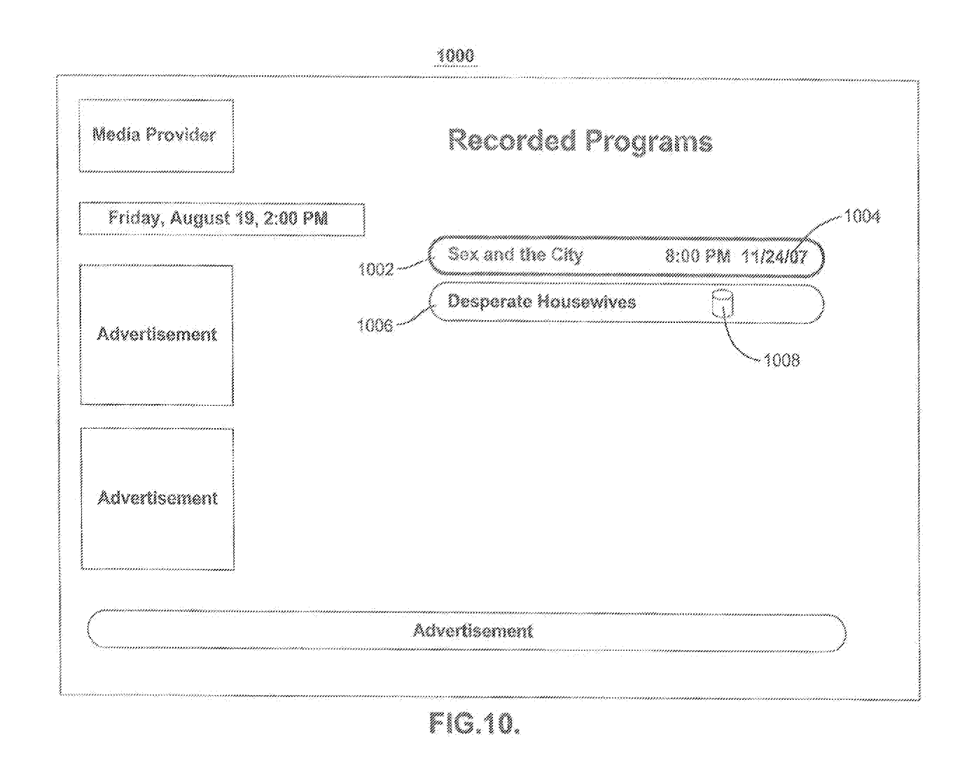

In more detail, the user may select to view the recorded sample by issuing a playback command. In response, the media guidance application may display a list of all recorded media content as illustrated in FIG. 10. Previously recorded media content 1002 may be displayed, for example, at the beginning of the list and be accompanied by the time and date 1004 of the recording. Media content 1006 scheduled to be recorded in the future may be displayed next and may be accompanied by an icon 1008 that indicates the media content is scheduled for recording. A user may request play-back of a recorded media content by highlighting a media content listing in the display 1000 and then pressing “Enter” or another command on the user input device 310. In response to the user request, the media guidance application issues a play-back request to either the local storage device 308 or a remote storage device. The play-back request may include an identifier for the media content that the user wishes to play back and an identifier of the user. The play-back request may also include a pointer to a media directory on the local or remote storage device. The local or remote storage device then retrieves the requested media content and provides it to the user equipment device 300 as a suitable signal such as an NTSC video signal or an MPEG-2 video signal. The media content may be transferred to the user equipment device 300 in real time or in a compressed form such as a compressed video file.

After the user has viewed at least a portion of the recorded sample, the media guidance application may provide a recording option or a media guidance application function. For example, the media guidance application may present an option to record an entire version of the recorded sample, record another episode of the media content, record an entire series of the media content, and/or record missed episodes of the media content. The user may also be presented with an option to erase the recorded sample or an option to perform other media guidance application functions described below. These and other options may be presented on a recording options screen displayed by the media guidance application.

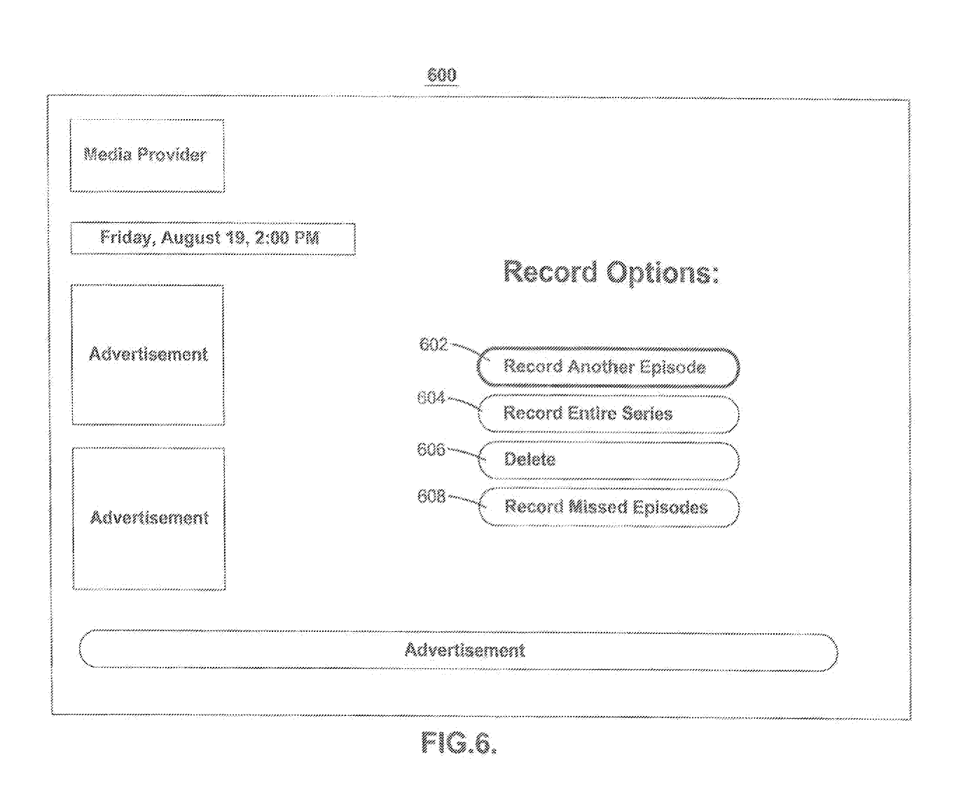

FIG. 6 illustrates an exemplary recording options screen 600 in accordance with an embodiment of the invention. The recording options screen 600 is displayed after a user has viewed or otherwise accessed at least a portion of a recorded sample. Recording options screen 600 may include Record Another Episode selection 602, Record Series selection 604, and Delete selection 606. A user may navigate between any of these selections using user input device 310. For example, a highlight region (shown on selection 602) may be moved about screen 600 when the user presses an arrow button on a remote control device. After picking one of the selections 602, 604, 606, the user may be presented with additional options. For example, if selection 602 is chosen, an additional display screen or overlay may list available episodes related to the recorded sample and prompt the user to select one or more of the episodes to record. Similarly, if selection 604 is chosen, a display screen which permits the user to record and/or manage an entire series related to the recorded sample may be displayed. If selection 606 is chosen, the media guidance application may simply erase the recorded sample or may first present a message asking the user to confirm the erase instruction.

The options screen 600 or a similar screen may also include a Record Missed Episodes selection 608. If this selection is chosen, the media guidance application may automatically search for and schedule the recording of all missed episodes of a series. An additional display screen or overlay may also provide the user the option to record only missed episodes in the current season of the media content or missed episodes in all seasons of the media content.

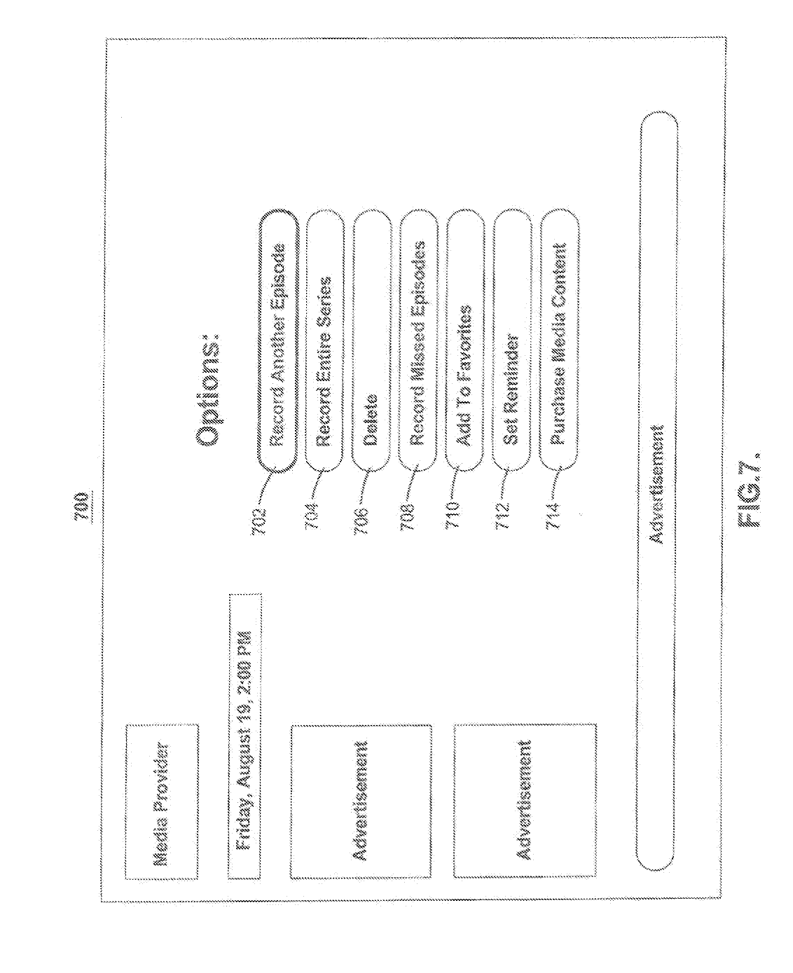

Other media guidance application function options may also be presented to the user after viewing at least a portion of the recorded sample. For example, FIG. 7 illustrates an additional media guidance application function options screen 700 in accordance with an embodiment of the invention. Options screen 700 may include Record Another Episode selection 702, Record Series selection 704, Delete selection 706, and Record Missed Episodes selection 708. Selections 702, 704, 706, and 708 have the same functionality as selections 602, 604, 606, and 608 of option screen 600. In addition, options screen 700 may include Add To Favorites selection 710, Set Reminder selection 712, and Purchase Media Content selection 714. Although not illustrated in FIG. 7, and particularly relevant to those users who discover a program in the middle of the first season or in subsequent seasons, an option to obtain missed episodes aired earlier that season or in earlier seasons via pay-per-view (PPV), video-on-demand (VOD), Internet download, DVD purchases, etc., may also be provided. Option screens 600 or 700 may also present selections for sending a message about the media content to another user, sending a recording of the media content to another user, creating a recommendation for the media content, rating the media content, and creating a parental control lock for the media content.

Importantly, the display screen 600 of FIG. 6, the display screen 700 or FIG. 7, or a similar display screen is presented only after a user has viewed at least a portion of a recorded sample. This allows the user to decide whether he or she likes the media content before committing to the recording of more related media content such as more episodes or an entire series. In a specific embodiment, the display screen of FIG. 6 or FIG. 7 is presented to a user after the user has viewed an entire sample of the recorded media content. For example, if the recorded sample is a television program episode, one of the options screens 600 or 700 is displayed after a user views the entire recorded episode. Alternatively, one of the screens 600, 700 may be displayed every time the user pauses or stops playback of the sample, at pre-determined time intervals (for example, every 5, 10, or minutes of playback time for the recorded sample), or at some pre-determined time (for example, 5 minutes, 1 hour, or 1 day) after the user has stopped playback of the sample. It is advantageous, however, that screen 600 of FIG. 6 or screen 700 of FIG. 7 or similar display screen be displayed only after the user has had an opportunity to view or otherwise access at least a portion of the recorded sample.

In another exemplary embodiment of the invention, an interactive media guidance application implemented at least partially on the user equipment device 300 permits sampling of media content which has been recommended to the user. The media content may be recommended by an editor or based at least in part on user profile information derived from historical user viewing information and/or user profile information. After the user has viewed or otherwise accessed at least a portion of a recommended media content, the user is presented with an option to record additional media content related to the recommended sample or to perform other media guidance application functions.

For example, the media guidance application may provide programming recommendations and picks from movie and television critics, sponsors, advertisers, and other interested third-parties, which are all generically referred to herein as “editors”. Details of such editor picks are described in more detail in pending U.S. patent application Ser. No. ______, entitled SYSTEMS AND METHODS FOR PROVIDING CUSTOM EDITORIAL PROGRAMMING PICKS, hereby incorporated by reference in its entirety. Some of these recommendations and picks may be based at least in part on viewer ratings and popularity information, such as the popular Nielson television ratings. Other recommendations and picks may be based on a set of common content criteria, including such attributes as character, actor, director, theme, or genre. For example, an editorial pick of the best episodes of the program series Seinfeld may be suggested to a user. As another example, various programs featuring Jerry Seinfeld as a character or actor (and optionally meeting one or more ratings criteria) may be suggested to the user in one or more convenient sets of editorial programming picks.

In other embodiments, the media guidance application may recommend or suggest particular episode picks (i.e., subsets of episodes of a program series) to the user based on user profile information derived from user history information and user monitoring. For example, using a scoring system, episode picks featuring a common content criteria (e.g., a common character) may be suggested to the user if the user frequently watches episodes meeting the same content criteria. For example, if the user tends to watch episodes of a program series with a certain character featured in the episode (e.g., the character “Kramer” in the program series “Seinfeld”), but not other episodes, the media guidance application may suggest or recommend custom editor pick sets of the program series Seinfeld featuring Kramer (e.g., a Seinfeld pick set defined as “The Best Kramer Episodes”).

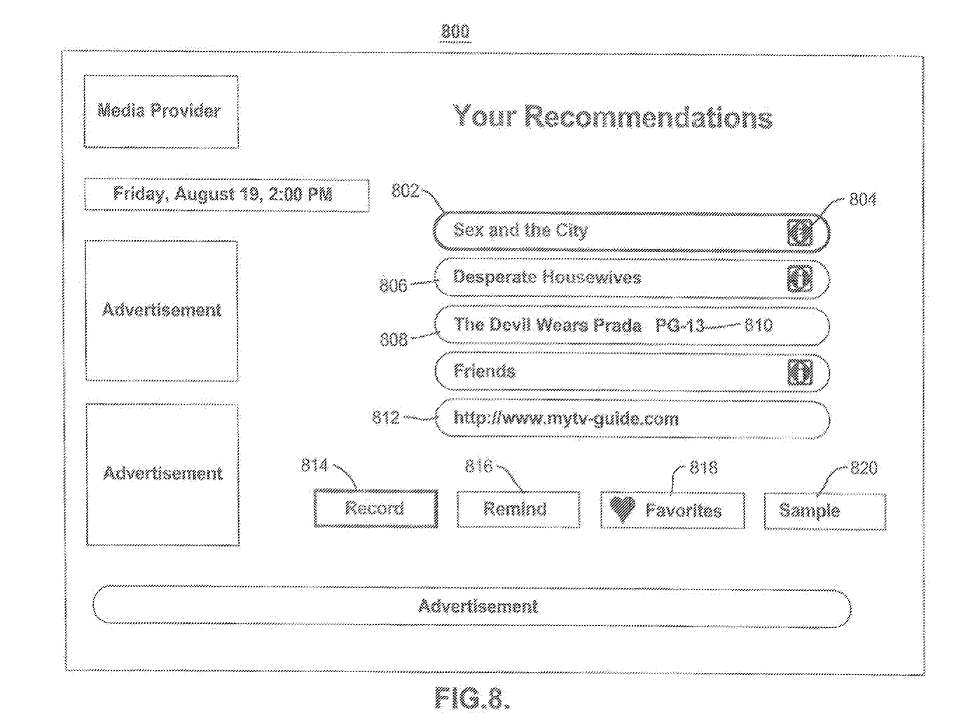

An illustrative recommendations screen 800 listing recommended programming is shown in FIG. 8. Recommendations screen 800 may list entire program series, selected episodes of a program series, or individual programming picks (e.g., feature movies and websites). The recommendations may include any content accessible by the user equipment device 300, including, for example, on-demand content, recorded content, pay-per-view content, Internet content, and interactive applications and games. Picks 802 and 806 include episode picks for the program series “Sex and the City” and “Desperate Housewives,” respectively. Because these entries are associated with more than one program or episode, details icon 804 may be displayed. Pick 808 includes an on-demand feature movie with rating 810. Pick 812 may include an Internet website.

The user may select any recommendation in display screen 800 to view the details (for example, a listing of the programs in the series, ratings information, previews, broadcast times, channels, or any other suitable information). To view more information about a recommendation, the user may press an “Info” button on user input interface 310. Internet content entries, such as website pick 812, may refer to the website domain generally or to multiple, specific pages within the domain or site.

To perform a media guidance application function on a recommendation listed in recommendations screen 800, the user may select from common media guidance application functions using buttons 814, 816, and 818. Some of the media guidance application functions may not apply to certain programming picks (e.g., Internet content), and buttons 814, 816, and 818 may be enabled or disabled depending on the programming pick or pick set currently selected. Other media guidance application functions (other than those specifically displayed in display screen 800) may also be performed by pressing a suitable button on user input interface 310. For example, parental locks may be enforced for certain programming.

To schedule a recommendation for conventional recording, the user may select record button 814. After selecting record button 814, the user may be presented with several recording options. For example, a record options overlay may be displayed which includes a record all option and a record selected option. To schedule all programs or episodes within the programming pick set, the user may select the record all option. To select individual programs or episodes for recording, the user may select the record selected option. After selecting the record selected option, a listing of the programs or episodes in the programming pick set may be displayed to the user. Corresponding options (similar to those options presented in the record options overlay) may be displayed to the user for any other media guidance application function (e.g., setting a reminder for the programming pick or adding the programming pick to a favorite programs list).

To set a reminder for a programming pick or pick set, the user may select remind button 816. To add a programming pick or pick set to a favorite programs list, the user may select favorites button 816. It should be noted that more or less media guidance application function buttons may be displayed on display screen 800, if desired.

In accordance with the principles of the present invention, recommendation screen 800 may also include Record Sample button 820 to permit a user to record a sample of a recommended media content. If the user selects the Record Sample button 820, the media guidance application schedules recording of the selected recommendation and marks or otherwise identifies the it as a sample. The sample may be a portion of the recommendation (e.g. the first 15 minutes of a television program), the entire recommendation (e.g. an entire episode of a television program), or a preview. After a user views or otherwise accesses at least a portion of the recorded sample, the media guidance application function presents additional recording options or media guidance application function options.

The user may select to view the recorded sample by issuing a playback command as described above. After the user has viewed at least a portion of the recorded sample, the media guidance application may provide an option to schedule another recording of the media content. For example, the user may be presented with an option to record an entire version of the recorded sample, record another episode of the media content, record an entire series of the media content, record missed episodes of the media content, erase the recorded sample, add the media content to a favorites list, set a reminder for the media content, purchase the media content, send a message about the media content to another user, create a recommendation for the media content, rate the media content, and create a parental block. These and other options may be presented on a recording options screen such as screen 600 of FIG. 6 or screen 700 of FIG. 7, both of which are described in detail above.

As emphasized above, the display screen of FIG. 6 or FIG. 7 is presented only after the user has viewed at least a portion of the sample of the recommended media content. This allows the user to decide whether he or she likes the media content before committing to the recording of related media content such as more episodes or an entire series. The display screen of FIG. 6 or FIG. 7 may be presented to the user after the user has viewed the entire recommendation, every time the user pauses or stops playback of the sample, at pre-determined time intervals during playback, or at some pre-determined time after the user has stopped playback of the sample.

Each of the display screens in FIGS. 1, 2, 5-8, and 10 may include a number of panel advertisements and banner advertisements. The size, shape, and location of the aforementioned advertisements may be altered without departing from the spirit of the invention, and more or less advertisements than those shown may be displayed, if desired.

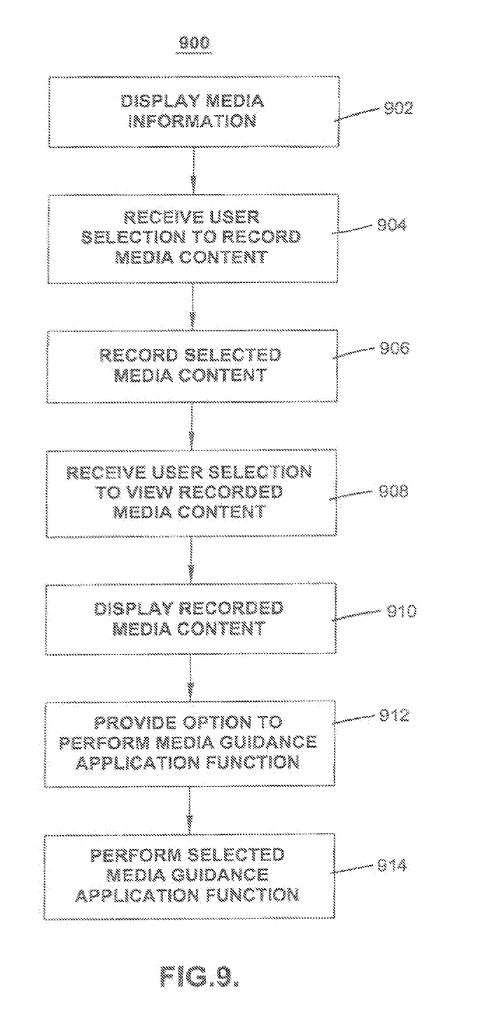

FIG. 9 shows exemplary process 900 for performing a media guidance application function for media content. At step 902, media information is displayed on display 312 of user equipment device 300. The media information may be provided by a media guidance application such as an interactive television program guide and may include a number of media content listings arranged by time and channel in a grid format.

At step 904, a user's selection to record a media content corresponding to one of the displayed media content listings is received by the media guidance application. The user may provide the recording instructions by placing a highlight region on the media content listing and pressing a “Record” button or other command button on an input device such as a remote control.

At step 906, the media content selected in step 904 is recorded to either a local storage device coupled with the user equipment 300 or to a remote storage device. The media guidance application may record a selected media content by tuning the user's equipment to the selected media content after it becomes available, sending a record command to a storage device to begin recording the content, and then stopping the recording at the conclusion of the media content. The steps performed to record media content on a remote storage device are disclosed in more detail in U.S. Patent App. Pub. No. 2005/028310 to Ellis et al., which is hereby incorporated by reference herein in its entirety.

At step 908, a user's selection to view the media content recorded in step 906 is received. In response, the media guidance application may display a list of all recorded media content as illustrated in FIG. 10. A user may request play-back of a recorded media content by highlighting a media content listing in display 1000 and then pressing “Enter” or another command on the remote control device. In response to the user request, the media guidance application issues a play-back request to either the local storage device or the remote storage device. The play-back request may include an identifier for the media content that the user wishes to play back and an identifier of the user. The play-back request may also include a pointer to a media directory on the local or remote storage device. The local or remote storage device then retrieves the requested media content and provides it to the user equipment as a suitable signal such as an NTSC video signal or an MPEG-2 video signal. The media content may be transferred to the user equipment in real time or in a compressed form such as a compressed video file.

After the user has viewed or otherwise accessed at least a portion of the recorded media content, step 912 provides an option to perform a media guidance application function on the recorded media content. For example, as illustrated in FIG. 6, the media guidance application may provide an option to record another episode of the media content, an option to record an entire series of the media content, an option to record missed episodes, and an option to delete the recorded media content. As illustrated in FIG. 7, the media guidance application may also provide the option to perform other media guidance application functions such as an option to add the media content to a favorites list, an option to set a reminder for the media content, and an option to purchase the media content. Other media guidance application function options may also be presented such as sending a message about the media content to another user, sending a recording of the media content to another user, creating a recommendation for the media content, rating the media content, and creating a parental control lock for the media content may also be presented.

A user may select any of the media guidance application functions by highlighting one of the options in FIG. 6 or 7 and then pressing “Enter” or another command on a remote control device. In response to a user selection of a media guidance application function in step 912, step 914 performs the selected media guidance application function. For example, if the user selects to record another episode of the media content, the media guidance application tunes the user's equipment to another episode of the media content and sends a record command to the local storage device or the remote storage device. If more than one additional episode of the media content is available, the media guidance application may list all available episodes and prompt the user to select one or more of them for recording.

Similarly, if the user selects to record an entire series of the media content, the media guidance application may schedule the recording of all episodes within the series. Series recording is described in more detail in U.S. Pat. No. 6,850,693 which is hereby incorporated by reference herein in its entirety.

If the user selects to record missed episodes, the media guidance application may automatically search for and schedule the recording of all missed episodes within a program series. Alternatively, and particularly relevant to those users who discover a program in the middle of the first season or in subsequent seasons, an option to obtain missed episodes aired earlier that season or in earlier seasons via pay-per-view (PPV), video-on-demand (VOD), Internet download, DVD purchases, etc., may also be provided.

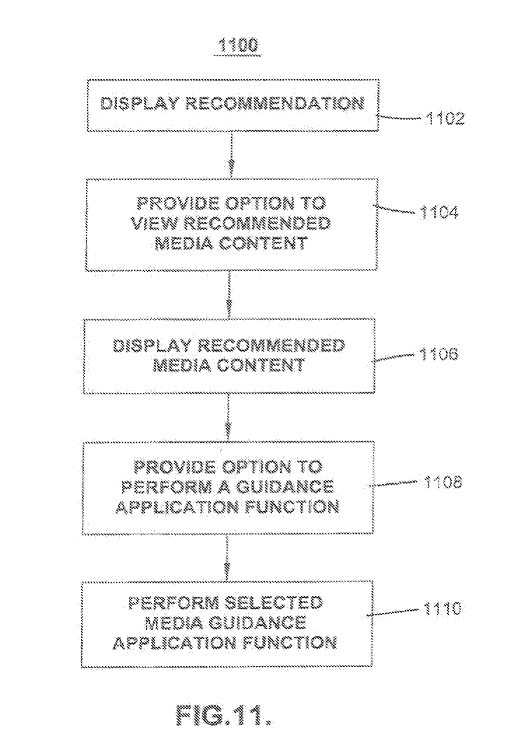

FIG. 11 shows illustrated process 1100 for performing a media guidance application function in accordance with another embodiment of the invention. Process 1100 is similar to process 800 except that process 1100 permits sampling of a media content that has been recommended to a user.

At step 1102, media information for recommended media content may be displayed on display 312 of user equipment device 300. As mentioned above, the media information may be provided by a media guidance application such as an interactive television program guide and may include a number of media content listings for recommended media contents. An exemplary recommendation display screen 800 is shown in FIG. 8. The recommended media contents may be previously recorded before being listed in recommendations display screen 800 or may be recorded upon user request as discussed above. For example, the media guidance application may display an option to record a sample of the recommendation as described above. When selected, the media guidance application schedules recording of the recommendation on a local or remote storage device.

At step 1104, a user's selection to view a recommended media content is received. In response to the user request, the media guidance application issues a play-back request to either the local storage device or the remote storage device as shown in step 1106. The local or remote storage device then retrieves the requested media content and provides it to the user equipment as a suitable signal such as an NTSC video signal or an MPEG-2 video signal, either in real time or in a compressed form such as a compressed video file.

After the user has viewed or otherwise accessed at least a portion of the recorded media content, step 1108 provides an option to perform a media guidance application function on the recorded media content. For example, as illustrated in FIG. 6, the media guidance application may provide an option to record another episode of the media content, an option to record an entire series of the media content, an option to record missed episodes of the media content, and an option to delete the recorded media content. As illustrated in FIG. 7, the media guidance application may also provide the option to perform other media guidance application functions such as an option to add the media content to a favorites list, an option to set a reminder for the media content, and an option to purchase the media content. Options to perform other media guidance application functions such as sending a message about the media content to another user, sending a recording of the media content to another user, creating a recommendation for the media content, rating the media content, and creating a parental control lock for the media content may also be presented.

A user may select any of the media guidance application functions by highlighting one of the options in FIG. 6 or 7 and then pressing “Enter” or another command on a remote control device. In response to a user selection of a media guidance application function in step 1108, step 1110 performs the selected media guidance application function. For example, if the user selects to record another episode of the media content, the media guidance application tunes the user's equipment to another episode of the media content and sends a record command to the local storage device or the remote storage device. If more than one additional episode of the media content is available, the media guidance application may list all available episodes and prompt the user to select one or more of them for recording.

Similarly, if the user selects to record an entire series of the media content, the media guidance application may schedule the recording of all episodes within the series. Series recording is described in more detail in U.S. Pat. No. 6,850,693 which is hereby incorporated by reference herein in its entirety.

Although the invention has been described with reference to preferred embodiments illustrated and discussed herein, equivalents may be employed and substitutions made herein without departing from the scope of the invention as recited in the claims. For example, it will be appreciated that while the discussion of media content has focused on video content such as television programs, the principles of media guidance can be applied to other types of media content, such as music, images, etc. Similarly, while the recording options discussed herein have focused on the embodiments of broadcast episodes of a program series, other programming, such as Internet content, movies, specials, pre-recorded content, and on-demand content may also be recorded using the principles of the present invention.

Having thus described the preferred embodiment of the invention, wheat is claimed as new and desired to be protected by Letter Patent includes the following:

1. A method for performing media guidance application functions, the method comprising:
displaying media information including at least one media content listing;
receiving a first user selection to record a media content that corresponds to the media content listing;
in response to the first user selection, recording the media content on a storage device;
receiving a second user selection to view the recorded media content;
in response to the second user selection, displaying the recorded media content; and
after the user has viewed at least a portion of the recorded media content, providing the user an option to schedule a recording of an other media content related to the recorded media content.

2. The method as set forth in claim 1, wherein the media content is part of a series and the recorded media content and the other recorded media content are both episodes in the series.

3. The method as set forth in claim 1, wherein the providing step further includes the step of providing the user an option to schedule recording of a series of the media content.

4. The method as set forth in claim 1, wherein the providing step further includes the step of providing the user an option to erase the recorded media content from the storage device.

5. The method as set forth in claim 1, wherein the providing step further includes the step of providing the user an option to select a media guidance application function selected from the group consisting of: retaining the recorded media content on the storage device; adding the media content to a favorites list; setting a reminder for the media content; ordering the media content via an on-demand or pay-per-view service; sending a message about the media content to another user; sending a recording of the media content to another user; creating a recommendation for the media content; rating the media content; and creating a parental control lock for the media content.

6. The method as set forth in claim 1, wherein the providing step is performed after the user has viewed all of the recorded media content.

7. The method as set forth in claim 1, wherein the media information is provided by an interactive program guidance application, and wherein the media content is a program, and the media content listing is a program listing.

8. The method as set forth in claim 7, wherein the interactive program guidance application lists a plurality of program listings.

9. The method as set forth in claim 1, wherein the media content listing is displayed for the user in response to a recommendation of the media content.

10. The method as set forth in claim 9, wherein the recommendation is created based on the user's viewing habits.

11. A system for permitting a user to perform a recording function for media content, the system comprising:
a display device; and
control circuitry operable to—
display on the display device media information including at least one media content listing;
receive a first user selection to record a media content that corresponds to the media content listing;
record the media content on a storage device in response to the first user selection;
receive a second user selection to view the recorded media content;
display the recorded media content on the display device in response to the second user selection; and
provide the user an option to schedule a recording of an other media content related to the recorded media content after the user has viewed at least a portion of the recorded media content.

12. The system as set forth in claim 11, wherein the media content is part of a series and the recorded media content and the other recorded media content are episodes in the series.

13. The system as set forth in claim 11, wherein the control circuitry further provides the user an option to schedule recording of a series of the media content.

14. The system as set forth in claim 11, wherein the control circuitry further provides the user an option to erase the recorded media content from the storage device.

15. The system as set forth in claim 11, wherein the control circuitry further provides the user an option to select a media guidance application function selected from the group consisting of: retaining the recorded media content on the storage device; adding the media content to a favorites list; setting a reminder for the media content; ordering the media content via an on-demand or pay-per-view service; sending a message about the media content to another user; sending a recording of the media content to another user; creating a recommendation for the media content; rating the media content; and creating a parental control lock for the media content.

16. The system as set forth in claim 11, wherein the control circuitry provides the option after the user has viewed all of the recorded media content.

17. The system as set forth in claim 11, wherein the media information is provided by an interactive program guidance application, and wherein the media content is a program, and the media content listing is a program listing.

18. The system as set forth in claim 17, wherein the interactive program guidance application lists a plurality of program listings.

19. The system as set forth in claim 11, wherein the media content listing is displayed for the user in response to a recommendation of the media content.

20. The system as set forth in claim 19, wherein the recommendation is created based on the user's viewing habits.

21. A system for permitting a user to perform a recording function for a media content, the system comprising:
a media content source for storing media content;
a media guidance data source for storing media guidance data including media content listings;
a display device; and
control circuitry coupled with the display device and operable to—
receive a media content listing for a media content from the media guidance data source;
display the media content listing on the display device;
provide the user an option to record at least a portion of the media content;
provide the user an option to view the recorded media content;
receive a user selection to view the recorded media content;
in response to the user selection, display the recorded media content on the display device; and
after the user has viewed the recorded media content, provide the user an option to schedule a recording of another media content related to the recorded media content.

22. The system as set forth in claim 21, wherein the control circuitry further provides the user an option to schedule recording of a series of the media content.

23. The system as set forth in claim 21, wherein the control circuitry further provides the user an option to erase the recorded media content from the storage device.

24. The system as set forth in claim 21, wherein the control circuitry is implemented in a set-top box coupled with the display device.

25. The system as set forth in claim 21, wherein the control circuitry further provides the user an option to select a media guidance application function selected from the group consisting of: retaining the recorded media content on the storage device; adding the media content to a favorites list; setting a reminder for the media content; ordering the media content via an on-demand or pay-per-view service; sending a message about the media content to another user; sending a recording of the media content to another user; creating a recommendation for the media content; rating the media content; and creating a parental control lock for the media content.

26. The system as set forth in claim 21, wherein the control circuitry provides the option to schedule the recording of another media content after the user has viewed all of the recorded media content.

27. The system as set forth in claim 21, wherein the media information is provided by an interactive program guidance application, and wherein the media content is a program, and the media content listing is a program listing.

28. The system as set forth in claim 27, wherein the interactive program guidance application lists a plurality of program listings.

29. The system as set forth in claim 21, wherein the media content listing is displayed for the user in response to a recommendation of the media content.

30. The system as set forth in claim 29, wherein the recommendation is created based on the user's viewing habits.

31-41. (canceled)
